(19) United States
(12) Patent Application Publication
(10) Pub. No.: US 2026/0119360 A1
(43) Pub. Date: Apr. 30, 2026

(54) MIXED LLM INFERENCE FOR FASTER SERVICE

(71) Applicant: Cisco Technology, Inc., San Jose, CA (US)

(72) Inventors: Akshay Jajoo, San Jose, CA (US); Myungjin Lee, Bellevue, WA (US); Ramana Rao V.R. Kompella, Foster City, CA (US)

(73) Assignee: Cisco Technology, Inc., San Jose, CA (US)

(21) Appl. No.: 18/933,366

(22) Filed: Oct. 31, 2024

(51) Int. Cl. G06F 11/34

(52) U.S. Cl. CPC G06F 11/3409

(57) ABSTRACT

In one implementation, a device obtains performance metrics for a sequence of partitions of a first language model that sequentially process requests. The device makes, based on the performance metrics, a determination that a bottleneck partition exists in the sequence of partitions and represents a potential bottleneck or failure point for the first language model processing a request from a requester. The device identifies a partition of a second language model as an alternate for the bottleneck partition of the first language model. The device configures, based on the determination, a preceding partition that precedes the bottleneck partition in the sequence of partitions to send an output of the preceding partition to the partition of the second language model to process the request in lieu of the bottleneck partition.

### TECHNICAL FIELD

The present disclosure relates generally to computer networks and more particularly to mixed large language model (LLM) inference for faster service.

### BACKGROUND

The recent breakthroughs in large language models (LLMs), such as ChatGPT and GPT-4, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

Because of its size and resource requirements, an LLM may be partitioned into smaller blocks. In such cases, the LLM may process an incoming request in a sequential manner by passing the results of one block as input to the next block in the chain. Typically, each block is deployed independently on different virtual machines (VMs) or containers. However, in such a deployment, certain blocks of the LLM could present a bottleneck for serving user requests, thus leading to delayed service or, at worst, the query being dropped entirely.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of interfacing with a generative model;

FIG. 4 illustrates an example architecture for using partitioned large language models (LLMs);

FIG. 5 illustrates an example architecture for mixed LLM inference for faster service;

FIG. 6 illustrates an example simplified procedure for mixed LLM inference for faster service, in accordance with one or more implementations described herein.

### DESCRIPTION OF EXAMPLE IMPLEMENTATIONS OVERVIEW

According to one or more implementations of the disclosure, a device obtains performance metrics for a sequence of partitions of a first language model that sequentially process requests. The device makes, based on the performance metrics, a determination that a bottleneck partition exists in the sequence of partitions and represents a potential bottleneck or failure point for the first language model processing a request from a requester. The device identifies a partition of a second language model as an alternate for the bottleneck partition of the first language model. The device configures, based on the determination, a preceding partition that precedes the bottleneck partition in the sequence of partitions to send an output of the preceding partition to the partition of the second language model to process the request in lieu of the bottleneck partition.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

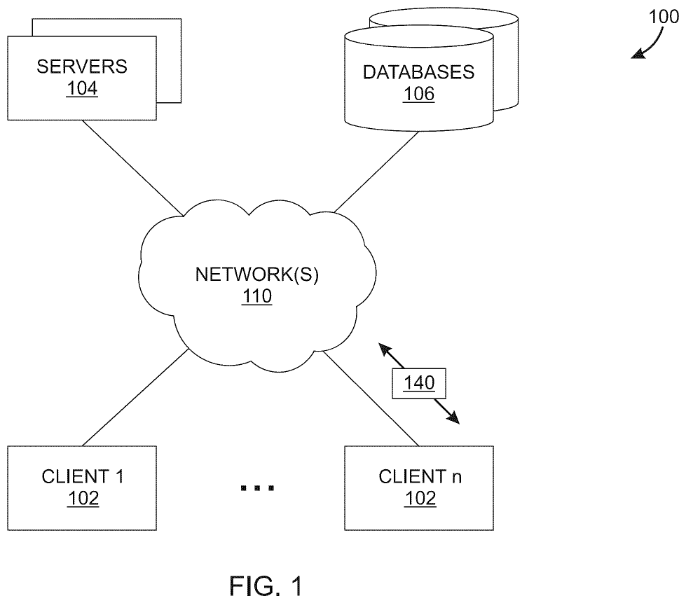

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

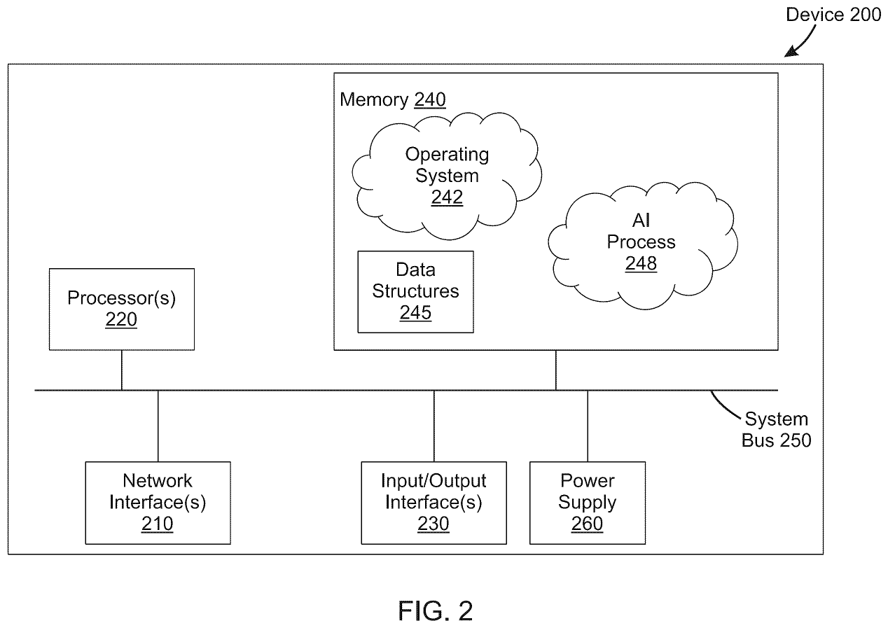

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize and/or be a component of machine learning implementations. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs), other transformer models, and the like.

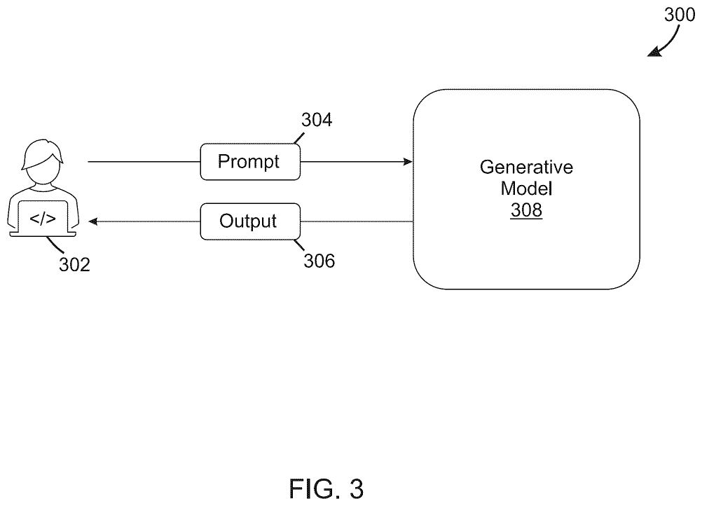

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM), diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, Because of its size and resource requirements, an LLM may be partitioned into smaller blocks. In such cases, the LLM may process an incoming request in a sequential manner by passing the results of one block as input to the next block in the chain. Typically, each block is deployed independently on different virtual machines (VMs) or containers. However, in such a deployment, certain blocks of the LLM could present a bottleneck for serving user requests, thus leading to delayed service or, at worst, the query being dropped entirely.

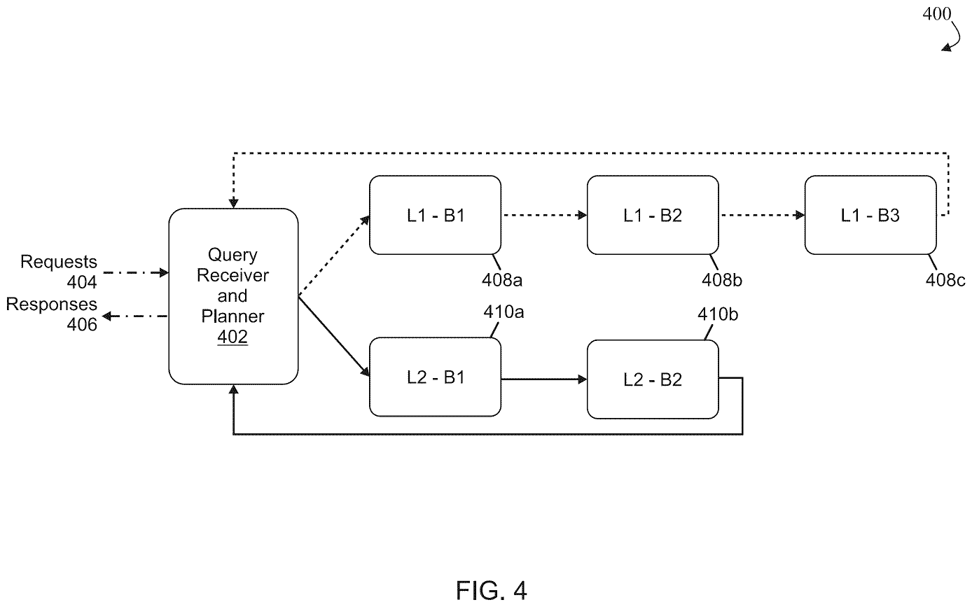

In addition, it is often the case that different LLMs are partitioned and hosted in the same compute cluster. For instance, FIG. 4 illustrates an example architecture 400 for using partitioned LLMs. As shown, assume that an LLM 408 has been partitioned into three blocks: block 408a (denoted L1-B1), block 408b (denoted L1-B2), and block 408c (denoted L1-B3). Architecture 400 may execute each of these blocks/partitions in different VMs, containers, or even on different devices that are in communication with one another via a network.

Also as shown, assume that there is another LLM 410 hosted in the cluster depicted by architecture 400 that has similarly been partitioned into two blocks: block 410a (denoted L2-B1) and block 410b (denoted L2-B2). Like that of LLM 408, architecture 400 may execute the partitions of LLM 410 on different VMs, containers, or devices in the same cluster as that of LLM 408.

Each of LLM 408 and LLM 410 may process an incoming request sequentially. For instance, block 408a may receive the incoming request sent by a user or other requester (e.g., an agent, a bot, etc.), process it, and send its results to block 408b for input. Block 408c may then process the output of block 408b to produce a final result, which is then returned to the requester. LLM 410 may itself represent a separate processing path, with an incoming request being input to block 410a for processing and its output sent to block 410b for input, to generate the final result that is returned to the requester. As would be appreciated, while only two LLMs are shown with three partitions and two partitions in architecture 400, respectively, this is for illustrative purposes only and other architectures may include any number of LLMs that are each partitioned into any number of blocks, as desired.

To select which processing path/LLM to use, architecture 400 may include a query receiver and planner 402 (e.g., a component of AI process 248). In such a case, query receiver and planner 402 may assess the requests 404 from the requesters and route them to the appropriate LLM. For instance, requests 404 may include any or all of the following:
The query itself.
An indication of the model to use (e.g., LLM 408 or LLM 410).
Optionally, any quality of service (QOS) or other latency requirements for processing the query (e.g., a priority level, a maximum processing time, etc.).
Optionally, any performance requirements for the response (e.g., an accuracy metric, etc.).

One challenge with respect to partitioning a machine learning model, such as an LLM, stems from the fact that any bottlenecks or other performance issues associated with any of its constituent partitions/blocks will affect the overall performance of the system. For instance, consider the case in which block 410b is unavailable or otherwise busy. In such a case, a request routed by query receiver and planner 402 to LLM 410 may fail to complete or may fail to meet any QoS requirements specified in the request (e.g., may not complete within a desired amount of time, etc.

### —Mixed LLM Inference for Faster Service—

The techniques introduced herein aid in speeding up the processing of queries in a mixed LLM system that includes multiple, partitioned LLMs. More specifically, rather than waiting for a particular partition of an LLM to perform a processing task, the system herein is able to reroute that processing task to a partition of a different LLM that is similar to that of the original partition. Further aspects of the techniques herein also provide for consideration of the potential loss of accuracy when making such a rerouting decision.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device obtains performance metrics for a sequence of partitions of a first language model that sequentially process requests. The device makes, based on the performance metrics, a determination that a bottleneck partition exists in the sequence of partitions and represents a potential bottleneck or failure point for the first language model processing a request from a requester. The device identifies a partition of a second language model as an alternate for the bottleneck partition of the first language model. The device configures, based on the determination, a preceding partition that precedes the bottleneck partition in the sequence of partitions to send an output of the preceding partition to the partition of the second language model to process the request in lieu of the bottleneck partition.

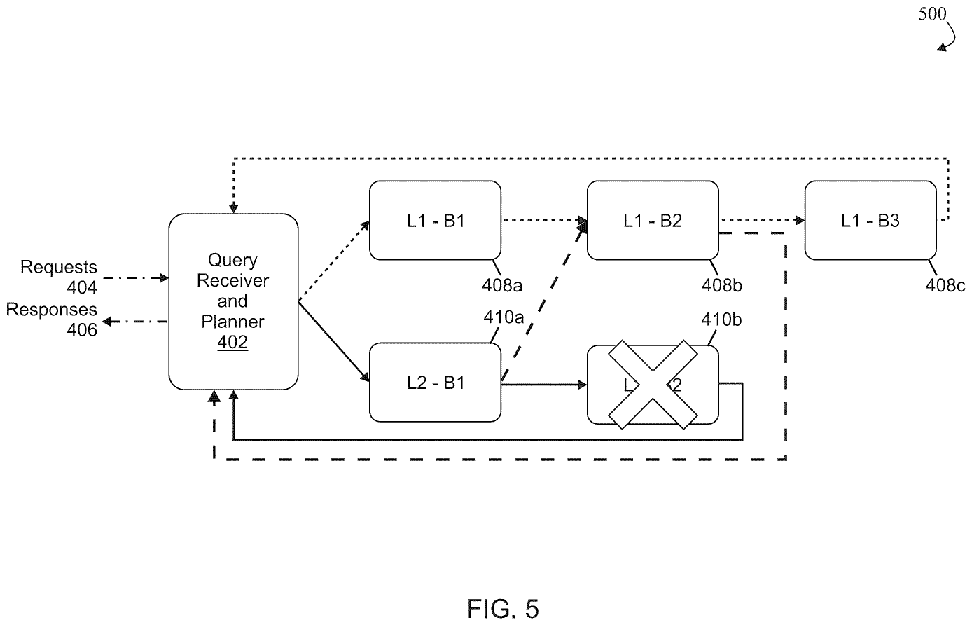

Operationally, FIG. 5 illustrates an example architecture 500 for mixed LLM inference for faster service, according to various implementations. Continuing the example of FIG. 4, again assume that there are two partitioned LLMs: LLM 408 and LLM 410 that are each partitioned. Now, assume that block 410b is exhibiting a bottleneck condition (e.g., due to it being busy, hardware or software issues, communication issues, etc.). Assume further that while block 408b is a partition of a different LLM (i.e., LLM 408), it is similar to that of block 410b.

According to various implementations, query receiver and planner 402 may monitor the response times of the different paths/LLMs and keep track of their processing metrics for each of their constituent blocks. Query receiver and planner 402 may also leverage a watchdog mechanism to check the availability/current usage of each block. Based on these pieces of information, the query receiver and planner 402 may determine the availability of a particular partition/block at any given time.

To determine the performance along any given path, query receiver and planner 402 may also maintain an offline profile of the characteristics of queries and LLMs (and its blocks) and use that to guide the routing decisions, combined with the online information like runtime delay, block availability, etc.

By way of example, as shown, rather than routing the output of block 410a to block 410b, query receiver and planner 402 may route that output to block 408b, to produce the response that query receiver and planner 402 returns to the requester. Here, by determining that block 410b is experiencing a problem (e.g., its processing latency is greater than a defined threshold, it is unreachable, its processing queue is above a certain limit, etc.), query receiver and planner 402 may notify block 410a that it should send its output to block 408b. Likewise, query receiver and planner 402 may notify block 408b that it should send its output back to query receiver and planner 402.

In some implementations, query receiver and planner 402 may base its rerouting decisions on any or all of the following factors:
The current processing latency of block 410b.
The anticipated latency associated with routing the request via block 410a and block 410b.
The anticipated latency associated with routing the request via block 410a and block 408b.
The current usage of block 410b.
The current usage of block 408b.
Any QoS or other latency requirements specified in the request.
Any default QoS or other latency requirements of the system.

According to various implementations, query receiver and planner 402 may further take into account the potential decrease in the performance of the system with respect to the resulting response. Indeed, even though block 408b may be able to process the output of block 410a despite being part of a different LLM, doing so may also lead to a decrease in the accuracy of the finalized response sent by query receiver and planner 402 back to the requester. Accordingly, query receiver and planner 402 may only reroute the request from block 410a to block 408b if the prediction accuracy will still satisfy the performance requirements specified in the request sent by the requester and/or any predefined thresholds set within the system.

Note also that the rerouting mechanism may be dynamic in nature and trigger before or after a request is sent for processing by any of the LLMs. For instance, in some instances, query receiver and planner 402 may initially configure block 410a to send its output to block 410b for a given request. However, based on real-time performance data regarding block 410b, query receiver and planner 402 may reconfigure block 410a to send its output instead to block 408b and configure block 408b to return its output back to query receiver and planner 402. In other cases, query receiver and planner 402 may make its routing decision before sending the request to block 410a for processing.

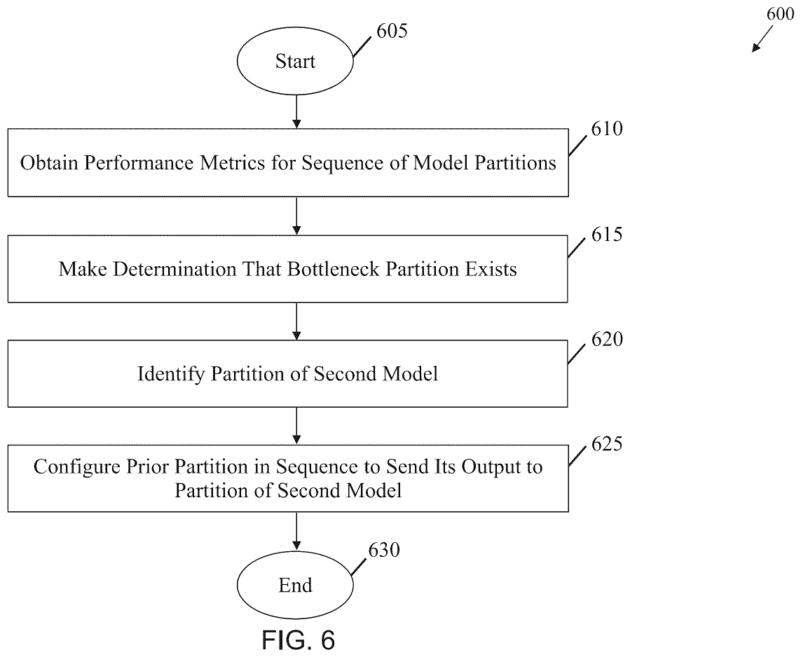

FIG. 6 illustrates an example simplified procedure for mixed LLM inference for faster service, in accordance with one or more implementations described herein. For example, a non-generic, specifically configured device (e.g., device 200), may perform procedure 600 (e.g., a method) by executing stored instructions (e.g., AI process 248). The procedure 600 may start at step 605, and continues to step 610, where, as described in greater detail above, the device (e.g., a controller, server, endpoint, etc.) may obtain performance metrics for a sequence of partitions of a first language model that sequentially process requests.

At step 615, as detailed above, the device may make, based on the performance metrics, a determination that a bottleneck partition exists in the sequence of partitions and represents a potential bottleneck or failure point for the first language model processing a request from a requester. In some cases, the device may also make an assessment that generating a response to the request using the partition of the second language model would satisfy one or more accuracy constraints, wherein the device configures the preceding partition in the sequence of partitions based further on that assessment. In one implementation, the request indicates one or more accuracy constraints. In a further implementation, the request indicates one or more latency constraints and the device makes the determination based in part on the one or more latency constraints. In a further implementation, the request includes an indication that the first language model should process the request.

At step 620, the device may identify a partition of a second language model as an alternate for the bottleneck partition of the first language model, as described in greater detail above. In various implementations, the first language model and the second language model are large language models. In some implementations, the sequence of partitions of the first language model and the partition of the second language model are executed in different virtual machines or containers.

At step 625, as detailed above, the device may configure, based on the determination, a preceding partition that precedes the bottleneck partition in the sequence of partitions to send an output of the preceding partition to the partition of the second language model to process the request in lieu of the bottleneck partition. In various implementations, the device may also configure, based on the determination, the partition of the second language model to provide its output as a response to the requester of the request. The device may also provide a response to the request generated in part by the partition of the second language model to a requester of the request. In some cases, the requester comprises one of: a user, a bot, or an agent.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for mixed LLM inference for faster service, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, performance metrics for a sequence of partitions of a first language model that sequentially process requests;
making, by the device and based on the performance metrics, a determination that a bottleneck partition exists in the sequence of partitions and represents a potential bottleneck or failure point for the first language model processing a request from a requester;
identifying, by the device, a partition of a second language model as an alternate for the bottleneck partition of the first language model; and
configuring, by the device and based on the determination, a preceding partition that precedes the bottleneck partition in the sequence of partitions to send an output of the preceding partition to the partition of the second language model to process the request in lieu of the bottleneck partition.

2. The method as in claim 1, wherein the first language model and the second language model are large language models.

3. The method as in claim 1, wherein the sequence of partitions of the first language model and the partition of the second language model are executed in different virtual machines or containers.

4. The method as in claim 1, further comprising:
configuring, by the device and based on the determination, the partition of the second language model to provide its output as a response to the requester of the request.

5. The method as in claim 1, further comprising:
making, by the device, an assessment that generating a response to the request using the partition of the second language model would satisfy one or more accuracy constraints, wherein the device configures the preceding partition in the sequence of partitions based further on that assessment.

6. The method as in claim 5, wherein the request indicates the one or more accuracy constraints.

7. The method as in claim 1, wherein the request indicates one or more latency constraints, and wherein the device makes the determination based in part on the one or more latency constraints.

8. The method as in claim 1, wherein the request includes an indication that the first language model should process the request.

9. The method as in claim 1, further comprising:
providing, by the device, a response to the request generated in part by the partition of the second language model to a requester of the request.

10. The method as in claim 9, wherein the requester comprises one of: a user, a bot, or an agent.

11. An apparatus, comprising:
one or more network interfaces;
a processor coupled to the one or more network interfaces and configured to execute one or more processes; and
a memory configured to store a process that is executable by the processor, the process when executed configured to:
obtain performance metrics for a sequence of partitions of a first language model that sequentially process requests;
make, based on the performance metrics, a determination that a bottleneck partition exists in the sequence of partitions and represents a potential bottleneck or failure point for the first language model processing a request from a requester;
identify a partition of a second language model as an alternate for the bottleneck partition of the first language model; and
configure, based on the determination, a preceding partition that precedes the bottleneck partition in the sequence of partitions to send an output of the preceding partition to the partition of the second language model to process the request in lieu of the bottleneck partition.

12. The apparatus as in claim 11, wherein the first language model and the second language model are large language models.

13. The apparatus as in claim 11, wherein the sequence of partitions of the first language model and the partition of the second language model are executed in different virtual machines or containers.

14. The apparatus as in claim 11, wherein the process when executed is further configured to:
configure, based on the determination, the partition of the second language model to provide its output as a response to the requester of the request.

15. The apparatus as in claim 11, wherein the process when executed is further configured to:
make an assessment that generating a response to the request using the partition of the second language model would satisfy one or more accuracy constraints, wherein the apparatus configures the preceding partition in the sequence of partitions based further on that assessment.

16. The apparatus as in claim 15, wherein the request indicates the one or more accuracy constraints.

17. The apparatus as in claim 11, wherein the request indicates one or more latency constraints, and wherein the apparatus makes the determination based in part on the one or more latency constraints.

18. The apparatus as in claim 11, wherein the request includes an indication that the first language model should process the request.

19. The apparatus as in claim 11, wherein the process when executed is further configured to:
provide a response to the request generated in part by the partition of the second language model to a requester of the request.

20. A tangible, non-transitory, computer-readable medium storing program instructions that cause a device to execute a process comprising:
obtaining, by the device, performance metrics for a sequence of partitions of a first language model that sequentially process requests;
making, by the device and based on the performance metrics, a determination that a bottleneck partition exists in the sequence of partitions and represents a potential bottleneck or failure point for the first language model processing a request from a requester;
identifying, by the device, a partition of a second language model as an alternate for the bottleneck partition of the first language model; and
configuring, by the device and based on the determination, a preceding partition that precedes the bottleneck partition in the sequence of partitions to send an output of the preceding partition to the partition of the second language model to process the request in lieu of the bottleneck partition.
